(19) United States
(12) Patent Application Publication
(10) Pub. No.: US 2014/0083592 A1
(43) Pub. Date: Mar. 27, 2014

(54) METHOD OF PRODUCING AN ELECTRICAL INSULATION SYSTEM FOR AN ELECTRIC MACHINE

(71) Applicants: Peter Gröppel, Erlangen (DE); Thomas Hildinger, Santana de Parnaiba (BR); Stefan Kempen, Arnsberg (DE); Steffen Lang, Erlangen (DE); Friedhelm Pohlmann, Essen (DE)

(72) Inventors: Peter Gröppel, Erlangen (DE); Thomas Hildinger, Santana de Parnaiba (BR); Stefan Kempen, Arnsberg (DE); Steffen Lang, Erlangen (DE); Friedhelm Pohlmann, Essen (DE)

(73) Assignees: VOITH PATENT GMBH, Heidenheim (DE); SIEMENS AKTIENGESELLSCHAFT, Munich (DE)

(21) Appl. No.: 14/115,346

(22) PCT Filed: Apr. 24, 2012
(86) PCT No.: PCT/EP2012/057482

§ 371 Date: Nov. 23, 2013

(30) Foreign Application Priority Data
May 6, 2011 (DE) 102011075425.3

(51) Int. Cl. H01B 13/08

(52) U.S. Cl. CPC H01B 13/0891
USPC 156/53

(57) ABSTRACT

A method for producing an electrical insulation system of a conductor of a winding head of an electric machine is provided. The method includes applying a porous main insulation paper to the conductor of the electrical machine; applying a porous overhang corona shielding paper to the main insulation paper, as a result of which an insulation blank of the insulation system is formed; impregnating the insulation blank with a base resin, wherein the overhang corona shielding paper and the main insulation paper have a porosity such that the insulation blank is impregnated by the base resin to form a homogeneous base resin matrix; and completing the insulation system by curing the base resin.

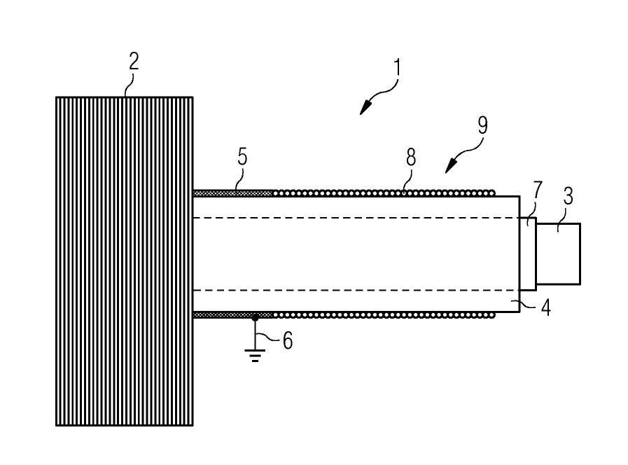

### CROSS REFERENCE TO RELATED APPLICATIONS

This application is the US National Stage of International Application No. PCT/EP2012/057482 filed Apr. 24, 2012, and claims the benefit thereof. The International Application claims the benefit of German Application No. DE 102011075425.3 filed May 6, 2011. All of the applications are incorporated by reference herein in their entirety.

### FIELD OF INVENTION

The invention relates to a method for producing an electrical insulation system for an electric machine.

### BACKGROUND OF INVENTION

A high-voltage machine, such as a turbogenerator in a power plant for generating electrical energy for example, is subject to a high level of mechanical, thermal and electrical loading. The turbogenerator has, in particular, a turbogenerator stator with a stator laminated core and a plurality of generator winding rods which are electrical conductors. The stator laminated core has a plurality of slots in which the conductors are mounted. In this case, the conductors project from the stator laminated core. The electrical insulation system envelopes each conductor and has the purpose of electrically insulating each conductor from adjacent conductors, from the stator laminated core and from the environment. The insulation system has a main insulation which envelopes the conductor and forms boundary areas with the stator laminated core and the conductor. During operation of the high-voltage machine, the main insulation can lift away from these boundary areas due to thermal or mechanical loading, as a result of which cavities are formed. At high operating voltages, sparks can form in these cavities, said sparks being caused by partial electrical discharges. This electrical loading of the main insulation can lead to said main insulation being damaged.

In order to prevent partial discharges at the boundary area between the main insulation and the conductor, a poorly conducting inner potential controller is provided. In order to prevent partial discharge at the boundary area between the main insulation and the stator laminated core, a poorly conducting and grounded external corona shielding which envelopes the main insulation is provided. Starting from the stator laminated core, the external corona shielding does not extend fully over the main insulation. Starting from the inner potential controller, the electrical field strength is reduced in the direction of the external corona shielding. In order to prevent partial discharges, the reduction in the electrical field is made more uniform by providing an overhang corona shielding. The overhang corona shielding extends from that end of the external corona shielding which is averted from the stator laminated core as far as the start of the end winding. In order to make the field strength more uniform, the overhang corona shielding is formed with a material which has an exponentially reducing electrical resistance as the voltage, that is to say the electrical field strength, increases. The overhang corona shielding therefore affects field control.

The overhang corona shielding has partially conductive particles which are embedded in a polymer. In this case, the polymer is either a constituent part of a coating or of a strip. If the polymer is a constituent part of the coating, the overhang corona shielding is applied to the main insulation in an additional working step after it has been impregnated and cured.

In the form of strips, the partially conductive particles are embedded in the polymer which saturates a woven, a laid scrim or a nonwoven. In this case, the polymer is in a so-called B-state. This means that the polymer is of adhesive-free design in order to allow further processing of the strip with a high degree of flexibility and strength. The polymer is partially crosslinked, so that the strip can be converted into its final form in a concluding curing process. The final form of the strip is distinguished by a high temperature resistance and dimensional stability. It is disadvantageous to apply this strip before the main insulation is impregnated because the polymer represents a diffusion barrier which makes it difficult to thoroughly impregnate the main insulation in a homogeneous and complete manner. For this reason, the overhang corona shielding strip is partially applied after the main insulation has been impregnated and cured, and is then thermally cured. Applying the strip to the main insulation after the main insulation has been impregnated and before said main insulation is cured is not realistic for health reasons (contamination of personnel by reactive resins).

In the form of a coating, the partially conductive particles are suspended in the polymer. The coating is applied to the cured main insulation at the corresponding points by immersion, spraying or coating. The coating is then dried and cured. One problem faced when applying the coating is that the layer thickness of the coating can fluctuate, this possibly leading to inadequate field control which is not sufficient to prevent partial discharges to a sufficient degree.

In both cases, that is to say when the overhang corona shielding is applied in the form of the strips or of the coating, either subsequent application of the overhang corona shielding after the main insulation has been impregnated and cured is complex in respect of production, or an overhang corona shielding which is applied before impregnation reduces the ability to impregnate said main insulation thoroughly. Furthermore, the subsequent application of the overhang corona shielding results in the formation of solid/solid boundary areas between the main insulation and the overhang corona shielding, as a result of which air pockets in which partial discharges are possible may form at this boundary area. The service life of the overhang corona shielding and the main insulation is reduced as a result.

### SUMMARY OF INVENTION

An object of the invention is to provide a method for producing an electrical insulation system for an electrical machine having an overhang corona shielding, wherein the service life of the insulation system is increased and production of said insulation system is simple.

In an embodiment, a method for producing an electrical insulation system for an electric machine includes: applying a porous main insulation paper to a conductor of the electric machine; applying a porous overhang corona shielding paper to the main insulation paper, as a result of which an insulation blank of the insulation system is formed; saturating the insulation blank with a base resin, wherein the overhang corona shielding paper and the main insulation paper have a porosity such that the insulation blank is saturated by the base resin to form a homogeneous base resin matrix; completing the insulation system.

On account of the base resin matrix being homogeneous, no solid/solid boundary area is formed between the overhang corona shielding and the main insulation, as a result of which the insulation system advantageously exhibits a high level of resistance in respect of the formation of air pockets. Furthermore, the overhang corona shielding can advantageously be applied with a reproducible layer thickness for complete field control. In addition, subsequent application of the overhang corona shielding system is not necessary, and therefore production is simple.

An embodiment of the method further includes: curing the base resin, so that the insulation system is completed. The main insulation paper preferably comprises mica paper, aluminum oxide paper and/or crêpe paper. The overhang corona shielding paper preferably exhibits a particle composite comprising partially conductive particles, in particular silicon carbide particles, microvaristors or particles with a partially conductive coating. The main insulation paper preferably has a carrier structure which increases the mechanical strength of the main insulation paper. Furthermore, the overhang corona shielding paper preferably has a carrier structure which increases the mechanical strength of the overhang corona shielding paper. The carrier structure is preferably a woven, a laid scrim and/or a nonwoven, wherein the carrier structure is adhesively bonded to the overhang corona shielding paper.

### BRIEF DESCRIPTION OF THE DRAWINGS

The invention will be explained in greater detail below with reference to the appended schematic drawing.

The figure shows a cross section through a turbogenerator stator having an insulation system which is produced in line with the method described herein.

### DETAILED DESCRIPTION OF INVENTION

As shown in the figure, a turbogenerator stator 1 has a stator laminated core 2 from which a generator winding rod 3 projects. The generator winding rod 3 is surrounded by a main insulation 4, wherein the winding rod 3 is arranged with its main insulation 4 and with one of its ends outside the stator laminated core 2. An external corona shielding 5 which envelopes the main insulation 4 and is grounded by a grounding means 6 is provided in the region of the point at which the winding rod 3 emerges from the stator laminated core 2. An inner potential controller 7 is also provided at the exposed longitudinal end of the main insulation 4. The overhang corona shielding 8 encloses the main insulation 4 starting from that end of the external corona shielding 5 which is averted from the stator laminated core 2 as far as the end of the main insulation 4. The insulation system 9 comprises the main insulation 4 and the overhang corona shielding 8.

An embodiment of the method will be explained in greater detail below with reference to an example.

A main insulation paper is applied to the generator winding rod 3. An overhang corona shielding paper is applied to the main insulation paper, specifically starting from the inner potential controller as far as the distance from the stator laminated core at which that end of the external corona shielding 5 which is averted from the stator laminated core is provided, as a result of which an insulation blank is formed. The insulation blank is saturated by a base resin, wherein the overhang corona shielding paper and the main insulation paper have a porosity such that the insulation blank is saturated by the base resin to form a homogeneous base resin matrix. Finally, the insulation system is cured by heat being supplied.

1. A method for producing an electrical insulation system for an electric machine, comprising:
applying a porous main insulation paper to a conductor of the electric machine;
applying a porous overhang corona shielding paper to the main insulation paper, as a result of which an insulation blank of the insulation system is formed;
saturating the insulation blank with a base resin, wherein the overhang corona shielding paper and the main insulation paper have a porosity such that the insulation blank is saturated by the base resin to form a homogeneous base resin matrix; and
completing the insulation system.

2. The method as claimed in claim 1, comprising:
curing the base resin, as a result of which the insulation system is completed.

3. The method as claimed in claim 1, wherein the main insulation paper comprises a mica paper, an aluminum oxide paper and/or a crêpe paper.

4. The method as claimed in claim, wherein the overhang corona shielding paper exhibits a particle composite comprising partially conductive particles, in particular silicon carbide particles, microvaristors or particles with a partially conductive coating.

5. The method as claimed in claim 1, wherein the main insulation paper has a first carrier structure which increases the mechanical stability of the main insulation paper.

6. The method as claimed in claim 1, wherein the overhang corona shielding paper has a second carrier structure which increases the mechanical strength of the overhang corona shielding paper.

7. The method as claimed in claim 5, wherein the carrier structure is a woven, a laid scrim and/or a nonwoven, wherein the carrier structure is adhesively bonded to the overhang corona shielding paper.
